(19) United States
(12) Patent Application Publication
(10) Pub. No.: US 2006/0290502 A1
(43) Pub. Date: Dec. 28, 2006

(54) Selective de-activation of RFIDs

(75) Inventor: Timothy W. Rawlings, Waynesville, OH (US)

Correspondence Address: DOUGLAS S. FOOTE;NCR CORPORATION, 1700 S. PATTERSON BLVD. WHQ5E, WHO-5E, DAYTON, OH, 45479, US

(73) Assignee: NCR Corporation

(21) Appl. No.: 11/166,981

(22) Filed: Jun. 24, 2005

(51) Int. Cl. G08B 13/14

(52) U.S. Cl. 340/572.1

(57) ABSTRACT

An approach to disabling an RFID. The operative range of an RFID is determined in part by the matching between the wavelength of the radiation used to communicate, and the length of the antenna used. Under the invention, the length of the antenna is changed, to reduce the operative range.

### BACKGROUND OF THE INVENTION

Radio Frequency Identification Devices, RFIDs, are small labels or tags which contain a radio transceiver and memory. Data is stored in the memory, and when the transceiver receives an incoming request signal from an external interrogating device, the transceiver transmits the stored data to the interrogating device.

RFIDs have multiple uses. For example, an RFID may be attached to a shipping container. The data stored in the RFID device can indicate (1) point of origin, (2) destination, (3) contents, and so on, and can act essentially as a bill of lading. An interrogating device can access the data without actually connecting to the RFID, but by merely coming into the operative range of the RFID.

In some situations, it is desirable to de-activate an RFID at certain times. For example, RFIDs are attached to items of merchandise in a retail shop. An interrogating device scans the items on display shelves, to determine the number and type of items present, for inventory control purposes. However, if a customer purchases an item, and remains in the shop with the item, it is not desirable that this item be counted as part of the shop's inventory.

As another example, RFIDs are used in connection with prescription pharmaceutical packaging, and can contain data about a patient. After the pharmaceuticals have served their purpose, the packaging is generally discarded. It is possible that the packaging can be scanned by a person equipped with an appropriate interrogation device. But it is not desirable that such persons be able to acquire the patient data from the discarded packaging.

As a third example, a household or office may contain several items which bear RFIDs. A stranger equipped with the proper interrogating device could be able to scan those RFIDs, and obtain confidential information. Such scanning is not desirable.

As a fourth example, during manufacture of RFIDs, quality control testing may ascertain some RFIDs as being defective, or otherwise deviating from optimal performance. It may be desirable to inactivate such RFIDs, so that they are not mistakenly used in place of RFIDs which are fully functional.

The invention proposes stratagems which selectively de-activate RFIDs, to solve problems illustrated by the preceding examples, and other problems.

### OBJECTS OF THE INVENTION

An object of the invention is to provide an improved RFID.

A further object of the invention is to provide an RFID which can be selectively de-activated.

### SUMMARY OF THE INVENTION

In one form of the invention, the radio-frequency antenna within an RFID is altered in geometry, thereby altering the field pattern of the antenna. The altered field pattern is ineffective to communicate with an interrogating device.

### BRIEF DESCRIPTION OF THE DRAWINGS

FIG. 1 illustrates schematically an RFID 3, together with its associated antenna 6.

FIG. 2 illustrates an example of selectively changing antenna geometry.

FIG. 3 illustrates adding an electrical connection to an RFID, which alters the physical length of the antenna.

FIG. 4 illustrates one approach to adding an electrical connection.

FIG. 5 illustrates a process of changing type of antenna, as opposed to changing antenna length, by adding an electrical connection.

FIG. 6 illustrates a specific example of changing antenna type, by adding an electrical connection.

FIG. 7 illustrates changing antenna length to zero by adding an electrical connection.

FIG. 8 illustrates a specific example of breaking an electrical connection, to alter the antenna.

FIG. 9 illustrates an operative principle used in PROMs, Programmable Read Only Memory. This principle can be used to break a connection in the invention.

FIG. 10 illustrates an RFID utilizing the principle of FIG. 9.

FIGS. 11 and 12 illustrates two forms of the invention.

### DETAILED DESCRIPTION OF THE INVENTION

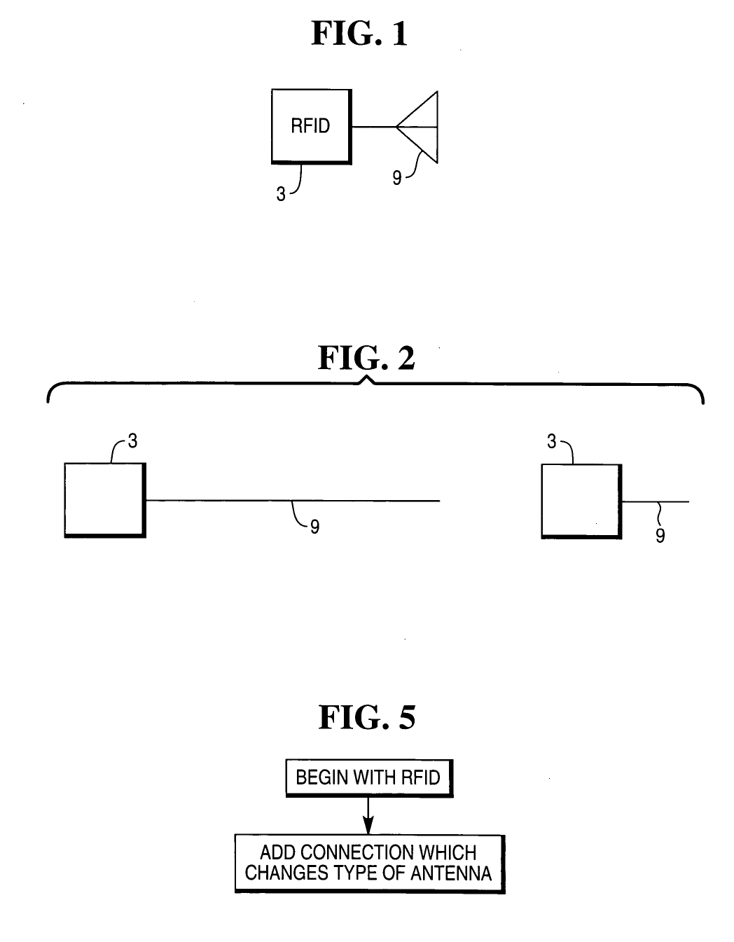

FIG. 1 illustrates schematically an RFID 3, together with its associated antenna 6. The RFID 3 generally takes the form of an integrated circuit, packaged within a protective housing.

Many RFIDs transmit and receive using frequencies on the order of 900 Mega-Hertz, MHz. In general, many types of antenna are equal in length to a fraction of the wavelength used, such as ¼, ½, and so on, and the radiation pattern of the antenna will change, as the wavelength changes. Similarly, the radiation pattern of the antenna will also change, if the length of the antenna changes, but the wavelength remains the same.

This principle also applies to RFIDs: the radiation pattern will change if the antenna length changes, but the wavelength remains constant.

One form of the invention utilizes this principle, by changing the length of the antenna of an RFID. This change alters the radiation pattern, in a manner which drastically reduces the reception and transmission range of the RFID.

FIG. 2 provides an example. Initially, the RFID 9 utilizes antenna 12 at the left side of the Figure. Then, the antenna 12 is shortened, as on the right side of the Figure.

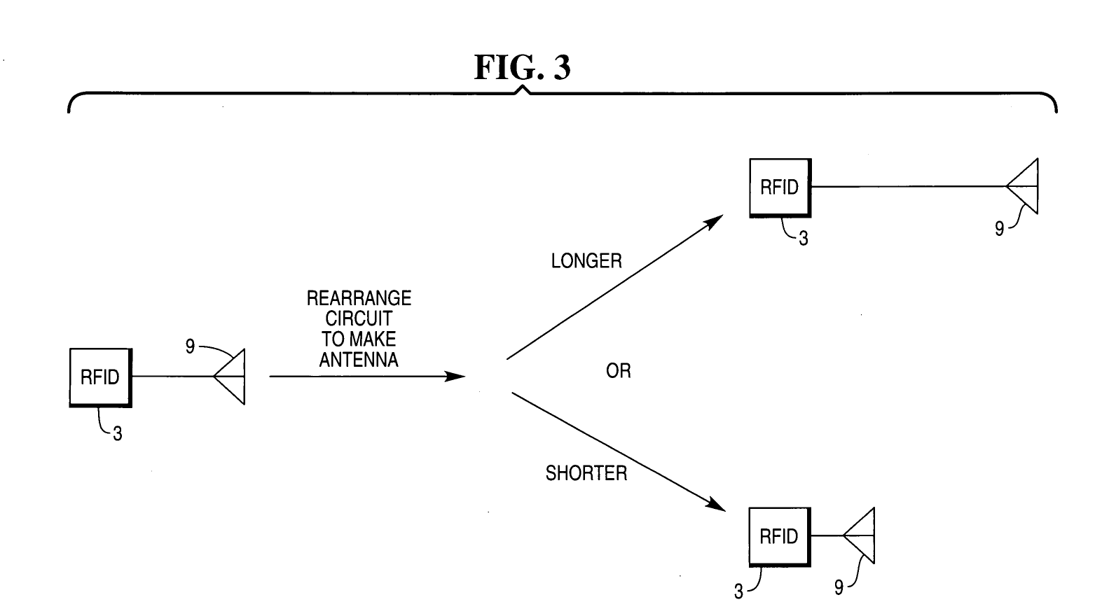

Several approaches can be taken to changing the antenna length. FIG. 3 illustrates one approach, wherein an electrical connection is added, which alters the antenna circuit, to shorten or lengthen the antenna. Alternately, the added connection can change the antenna from one type to another. In any case, the change alters the radiation pattern in the desired manner.

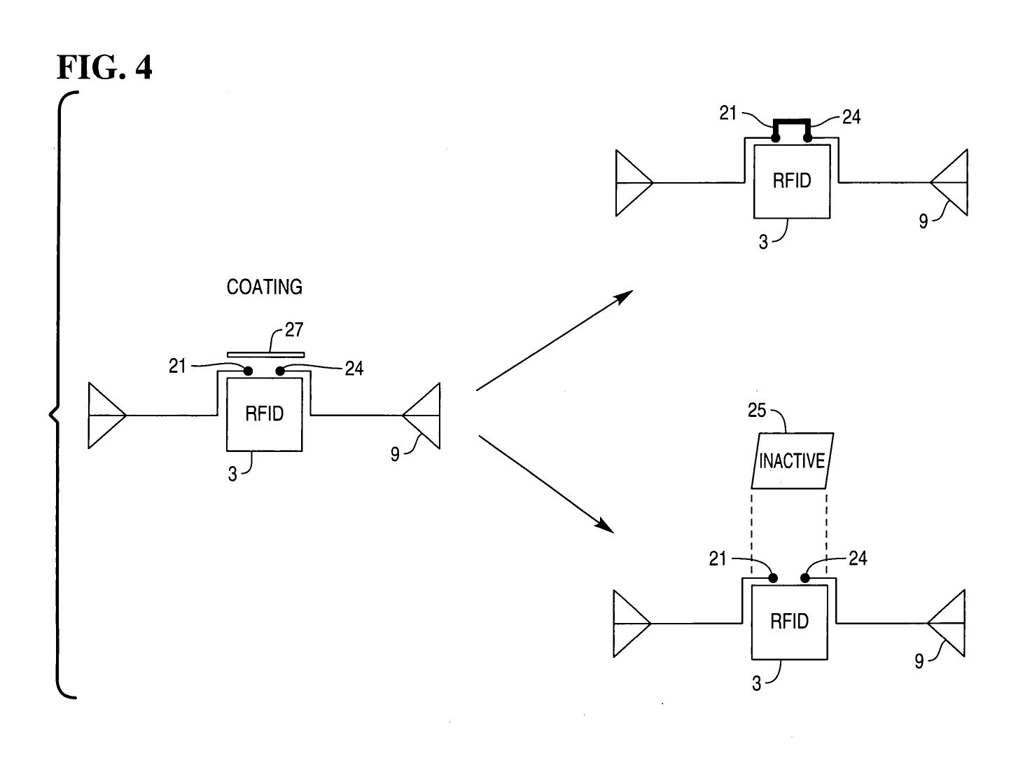

The electrical connection can be added in numerous different ways. For example, as in FIG. 4, the RFID can be equipped with two external contact pads 21 and 24, as shown on the left side of the Figure. These contact pads 21 and 24 are ordinarily coated with a protective substance 27, such as the coating used to obscure options on lottery tickets. To de-activate the RFID, the user takes a two-step approach. One, if the coating 27 is present, the user removes it, as by abrading it using the edge of a coin, as done with lottery tickets. Two, the user connects the two contact pads 21 and 24 together electrically.

The connection can be made by soldering a jumper wire W wire between the two contact pads 21 and 24, as shown at the upper right part of the Figure. Alternately, a conductive paint (not shown) can be applied between the two pads 21 and 24. As another alternate, a metallic foil 25 can be overlaid onto the contact pads 21 and 24. The foil can be attached by a conductive adhesive. The foil can be treated as a label, and can bear printed matter, such as the legend “INACTIVATED,” as indicated in the Figure.

The added connection can change the length of the antenna, as FIG. 4 indicates, thereby changing the radiation pattern, by effectively changing the length of the antenna, in terms of number of wavelengths of the radiation used. For example, the length can be changed from ¼ to 1/10 wavelength.

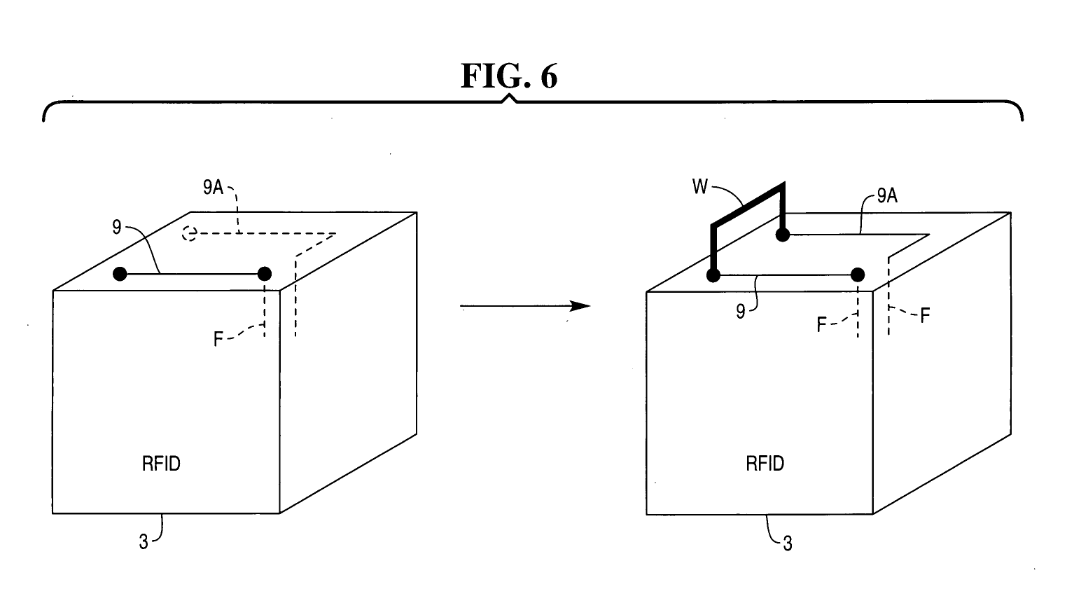

The added connection can also change the type of the antenna, as FIG. 5 indicates, thereby changing the radiation pattern. For example, as FIG. 6 indicates at the left, the antenna 9 was initially a linear antenna, using a feed F. Phantom conductors 9A are not initially used. Adding the jumper W, on the right of the Figure, connection changes the antenna to a loop antenna, which has different properties than does a linear antenna. The loop antenna is fed by two feeds F.

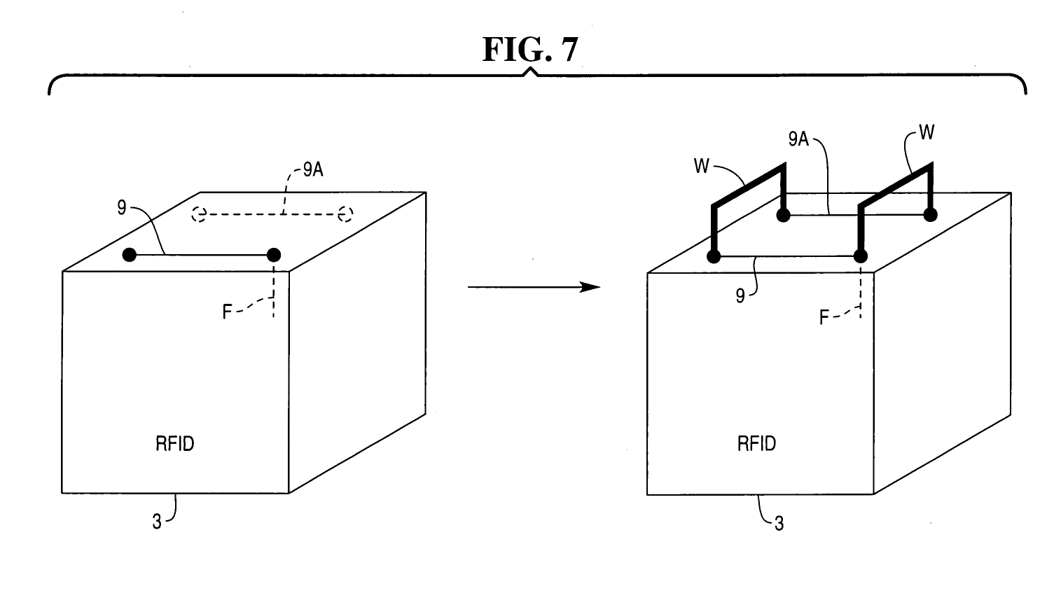

In another approach, the added connection changes the antenna length to zero, as in FIG. 7. The added jumpers W short-circuit the two ends of the antenna 9 together, through conductor 9A.

In another approach, an electrical connection is broken, thereby changing the length of the antenna, or the type of the antenna. In a sense, this approach is the converse of the addition of an electrical connection.

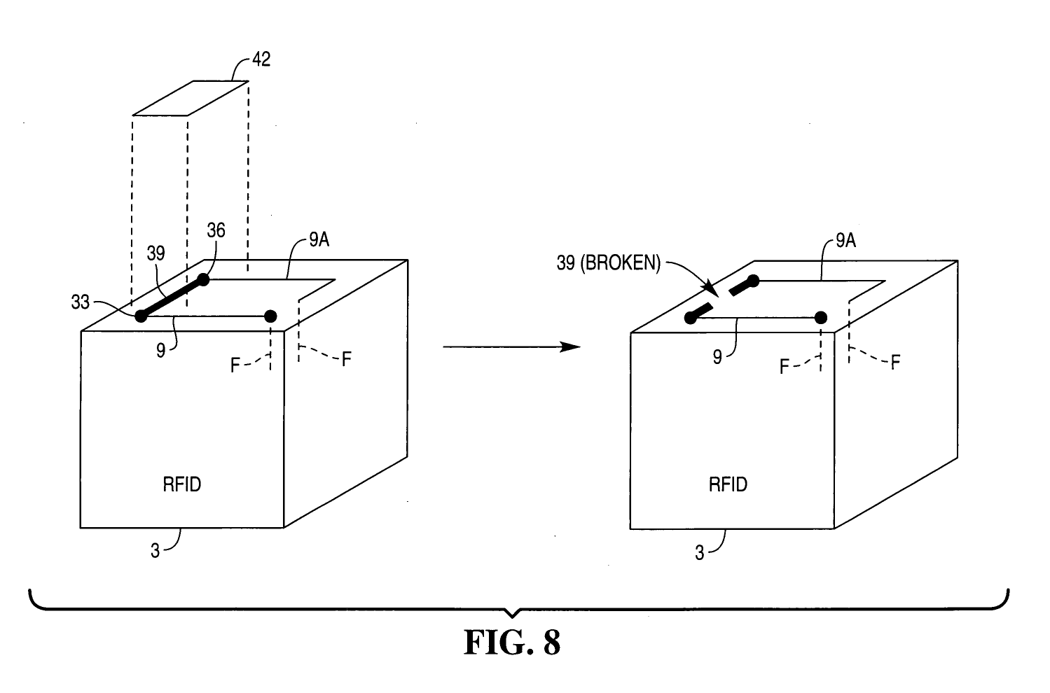

For example, the RFID 3 on the left side of FIG. 8 is equipped with external contacts 33 and 36. These contacts 33 and 36 are connected together by a fine wire or thin metallic foil 39. The wire/foil 39 can be protected by an optional protective layer 42, again resembling the protective coating used on lottery tickets. To break the connection, the user abrades away the coating 42 and the wire/foil 39, using a knife or the edge of a coin, producing the structure on the right side of FIG. 8, wherein the wire/foil 39 is now broken.

This approach can change the length or type of antenna, by reversing the procedures described in connection with FIGS. 3-7. For example, if the initial structure is that shown at the right side of FIG. 6, then breaking the jumper W as described in connection with FIG. 8 can produce the structure at the left side of FIG. 6.

In FIG. 8, the connection which is broken is external to, or on the surface of, the RFID 3. In another approach to breaking a connection, the connection in question is located internal to the RFID. The connection can take the form of a fusible material such as that used in Programmable Read Only Memories, PROMs.

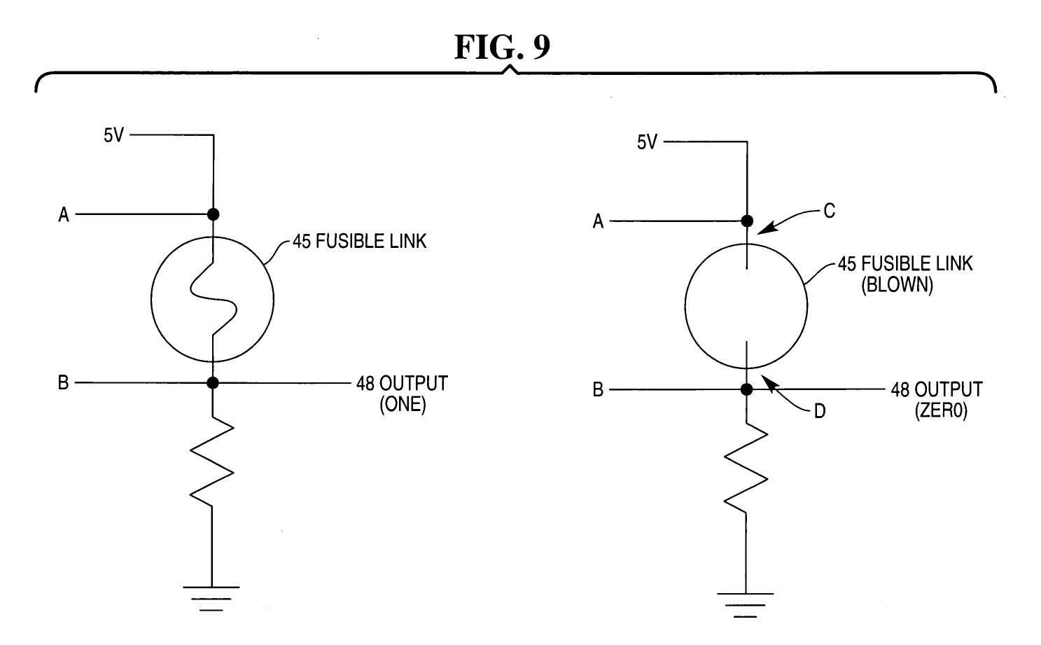

FIG. 9 illustrates a basic principle of a PROM, and shows one programmable bit. Initially, when the PROM is manufactured, as on the left side of the Figure, the fusible link 45 is intact. The output 48 is logical ONE, as indicated, because the output 48 is connected directly to five volts.

To re-program the PROM, a voltage is applied to points A and B. This voltage melts the fusible link 45, breaking the connection between points C and D, and changing the output to a logical ZERO, as shown on the right side of the Figure.

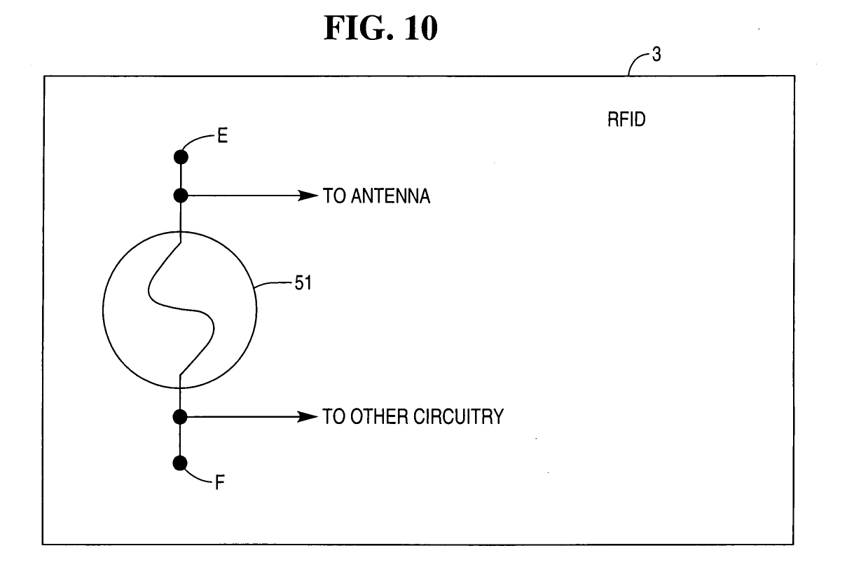

To apply this principle, an RFID is equipped with a fusible link 51, as that shown in FIG. 10. To change the radiation pattern of the antenna, a voltage is applied to points E and F, which melts fusible link 51. This breaks a connection, which can change antenna length, or type, as discussed above.

In one embodiment, points E and F are contact points, external to the RFID. Two probes (not shown) are applied to points E and F, and the probes are connected to a battery or power supply, which supplies the voltage needed to melt the fusible link 51.

Principles used by other types of memory can be used, to make and break electrical connections within the RFID. One example is the EPROM, Electrically Programmable Read Only Memory, which is programmed by application of voltages, and then erased by application of light, such as ultra-violet light.

Another example is the EEPROM, Electrically Erasable Programmable Read Only Memory, which is similar to the EPROM, except that voltage is used to erase the memory, instead of light.

Several of the preceding approaches utilized external contact points on the RFID, to cause a change in the topography of the antenna. That is, (1) an external jumper W was added, as in FIG. 6, (2) an external jumper W was broken, as in FIG. 8, or (3) an voltage was applied, as described in connection with FIG. 10.

In another approach, no external contact points are involved. Instead, a command to change the topography is issued by an interrogating device, and the RFID responds by closing one or more transistors. The closure applies a voltage to a fusible link, such as the fusible element 51 in FIG. 10.

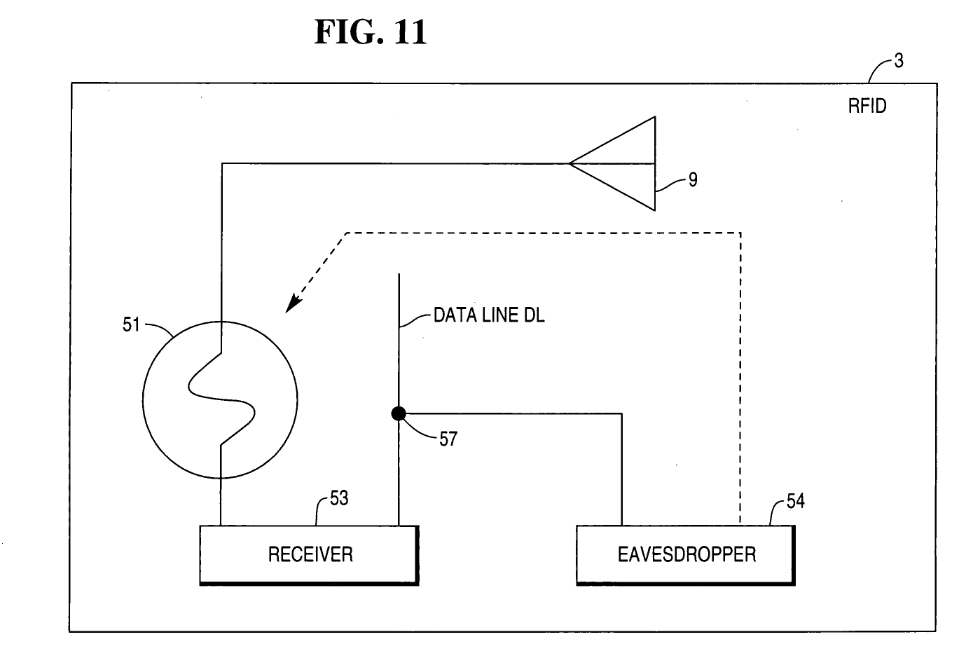

For example, FIG. 11 illustrates an RFID 3. A receiver 53 contains an output data line DL which carries data received from an interrogating device (not shown). An eavesdropping circuit 54 listens to that data, through tap 57. The eavesdropping circuit 54 does not affect the normal operation of the RFID, except in one instance, namely, when a specific sequence of data is received.

That specific sequence, in effect, is a code word that orders the eavesdropping circuit 54 into action. When that code word is received, the eavesdropping circuit 54 melts the fusible link 51, as indicated by the dashed arrow pointing to the link 51. The connection previously made by the fusible link 51 is now broken. This connection can correspond to that between points 33 and 36 in FIG. 6, for example. When it is broken, the antenna topography is altered.

Alternately, as shown in FIG. 11, the antenna 9 can be directly disconnected from the receiver 53, or other components needed to transmit and receive data.

Detection of the code word is known in the art. A common apparatus for detecting a specific sequence of bits is the “state machine”. State machines are described in Fundamentals of Logic Design, by Charles H. Roth, Jr., (West Pub. Co., 1985, ISBN 0-314-85292-1).

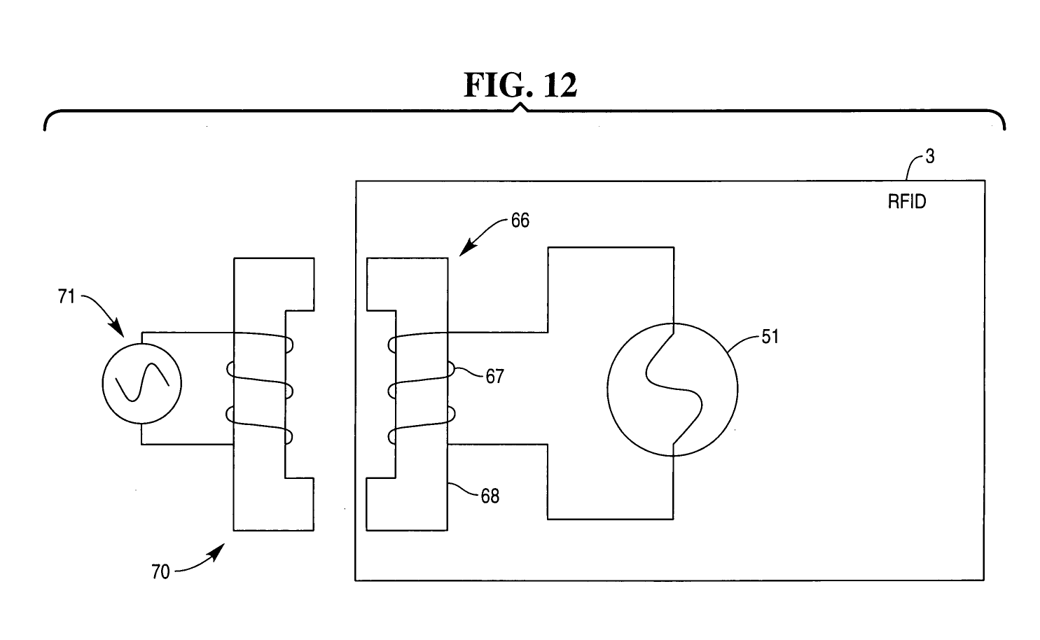

If a power supply is not available to apply a voltage to the fusible link 51 in FIG. 11, other alternatives are available. For example, in FIG. 12, an internal inductor 66, which includes a coil 67 and an iron core 68, is connected across the fusible link 51.

The inductor 66 acts as one-half of a transformer. To melt the fusible link 51, the user brings an external inductor 70 into registry with internal inductor 66, thereby creating a transformer. When an alternating current 71 is applied to the external inductor 70, a time-changing magnetic flux (not shown) is generated, which generates a voltage in the internal inductor 66. This voltage melts the fusible link.

In one embodiment, the external inductor 70 is mounted in a base, which is placed on a table. To inactivate an RFID, the user slides the RFID across the base, to thereby energize the internal inductor 66.

Alternately, the RFID may be equipped with a solar cell (not shown), in place of internal inductor 66. The solar cell may be covered by an opaque label, which prevents light from reaching it. To de-activate the RFID, the label is removed, thereby applying a voltage to the fusible link 51. Alternately, the solar cell can be designed so that ordinary sunlight is insufficient to fuse the link 51, but a more intense light is required.

### ADDITIONAL CONSIDERATIONS

1. In one form of the invention, an RFID responds to two types of incoming data. One type is an ordinary command, which requests the RFID to transmit the contents of its memory. Another type is a command to reconfigure antenna topography. This latter type of command can take the form of (1) adding electrical connections, or (2) breaking electrical connections. The latter type of command can take the form of (1) mechanical action which makes or breaks the connection, or (2) a signal which induces other apparatus to perform the making or breaking.

2. A distinction should be made between a superficially similar apparatus and the present invention. Apparatus exist which allow payment of a fee, by passing the apparatus near a sensor. For example, a toll can be paid to a toll gate on a toll highway by waving an appropriate card past a toll sensor. The amount of the toll is deducted from the card.

Such cards accomplish a function which could be viewed as similar to a function accomplished by the invention, namely, inactivation of the card upon occurrence of a specified event. The specified event is depletion of the amount of money stored in the card, whereupon the card is thought to become inactive.

However, at least two distinctions are present between such cards and the RFIDs of the invention. One is that it is believed that the cards do not actually become inactive. Instead, they merely fail to transmit the code required to satisfy the toll gate. And they may actually transmit a code indicating that their stored balance is insufficient to cover a toll. That is not true inactivity.

A second distinction is that such cards can be re-loaded with data indicating a replenished balance, and be re-used.

3. In another approach, the RFID antenna is disabled by attaching a metallic foil sheet 25, as in FIG. 4. The sheet reflects RF energy, and prevents it from escaping.

4. Many types of RFIDs are available. In general, one type is smaller than an ordinary mag-stripe credit card. An ANSII standard exists which defines dimensions of such cards.

Another type is smaller than 3×5×⅛ inches.

5. It is recognized that not all the approaches described above will de-activate an RFID with complete certainty. For example, the RFID contains internal wiring. It is well known that this wiring can act as an antenna. Thus, if a sufficiently strong signal is transmitted by an interrogation device, which is sufficiently close to the RFID, the RFID can pick up that signal, even if the RFID's antenna is completely removed. However, the RFID, in lacking the antenna, now transmits an extremely weak signal to the interrogation device.

Therefore, the invention contemplates reduction of the RFID's transmitted signal intensity by any and all of the following amounts: 50, 55, 60, 65, 70, 75, 80, 85, 90, 95, and 99 percent. Signal intensity refers to electric field strength, one foot from the RFID.

From another perspective, the invention contemplates reduction of the RFID's transmitted signal intensity, at one foot, by any and all of the following amounts: 20, 25, 30, 35, 40, 45, 50, 55, 60, 65, 70, 75, 80, 85, 90, 95, and 100 decibels, dB.

Numerous substitutions and modifications can be undertaken without departing from the true spirit and scope of the invention. What is desired to be secured by Letters Patent is the invention as defined in the following claims.

1. Apparatus, comprising:
a) an antenna;
b) an integrated circuit connected with the antenna, which
i) stores data in memory, and
ii) transmits stored data to the antenna, when a predetermined signal is received on the antenna; and
c) de-activation means for changing radiation pattern of the antenna.

2. Apparatus according to claim 1, wherein the de-activation means comprises signal contacts, accessible to a user.

3. Apparatus according to claim 2, wherein the signal contacts accept electrical signals.

4. Apparatus according to claim 1, wherein the de-activation means changes radiation pattern by altering antenna topography.

5. Apparatus according to claim 1, wherein the antenna and the IC are of the RFID type, Radio Frequency Identification Device.

6. Apparatus according to claim 1, wherein, after the de-activation means changes the radiation pattern, the apparatus does not transmit the stored data, in response to some of the predetermined signals.

7. Apparatus according to claim 1, wherein, after the de-activation means changes the radiation pattern, the transmitted field strength of the device, at one foot from the device, is reduced by at least 30 decibels.

8. A method, comprising:
a) receiving a device, smaller than credit card size, which
i) contains a radio transceiver, a radio antenna, and memory, and
ii) transmits data contained in memory in response to a predetermined signal received on the antenna; and
b) altering radiation pattern of the antenna, to thereby inhibit the response of paragraph (a)(ii).

9. Method according to claim 8, wherein the altering comprises bridging contacts on a surface of the device.

10. Method according to claim 8, wherein the altering comprises breaking contacts on a surface of the device.

11. Method according to claim 8, wherein the altering comprises breaking contacts internal to the device.

12. Method according to claim 8, wherein the altering comprises application of a conductive sheet to a surface of the device.

13. Apparatus, comprising:
a) a Radio Frequency Identification Device, RFID, which transmits data stored therein in response to a first type of incoming command signal; and
b) means for altering physical structure of the RFID, to thereby inhibit transmission of stored data in response to some of said first type of incoming command signals.

14. Apparatus according to claim 13, wherein the means connects, or disconnects, part of an electric circuit to the RFID.
